(19) United States
(12) Patent Application Publication
(10) Pub. No.: US 2025/0050446 A1
(43) Pub. Date: Feb. 13, 2025

(54) METHOD FOR CALIBRATING A LASER MACHINING SYSTEM

(71) Applicant: Precitec GmbH & Co. KG, Gaggenau (DE)

(72) Inventors: Tom Walde, Offenburg (DE); Rüdiger Moser, Malsch (DE); Li Wen Chang, Rastatt (DE); Dennis Hornbacher, Offenburg (DE)

(21) Appl. No.: 18/795,305

(22) Filed: Aug. 6, 2024

(30) Foreign Application Priority Data
Aug. 7, 2023 (DE) 10 2023 120 864.0

(51) Int. Cl. B23K 26/04; B23K 26/03; B23K 26/082

(52) U.S. Cl. CPC B23K 26/04; B23K 26/032; B23K 26/082

(57) ABSTRACT

A method for calibrating a laser machining system includes a scanner device for deflecting a laser beam to a plurality of positions on a surface and includes an observation device, an observation beam path of which runs coaxially to the laser beam path over the scanner device. The method includes calibrating the scanner device and calibrating the observation device. A laser machining system for machining a workpiece by means of a laser beam with a control configured to carry out said method is also provided.

### CROSS-REFERENCE TO RELATED APPLICATION

This application claims priority to German Patent Application No. 10 2023 120 864.0, filed Aug. 7, 2023, which is hereby incorporated by reference in its entirety.

### FIELD OF THE INVENTION

The present disclosure relates to a method for calibrating a laser machining system including a scanner device for deflecting a laser beam to a plurality of positions on a surface and including an observation device, the observation beam path of which runs coaxially to the laser beam path via the scanner device, comprising calibrating the scanner device and calibrating the observation device, as well as a laser machining system for machining a workpiece by means of a laser beam, configured to carry out the method.

### BACKGROUND OF THE INVENTION

In a system for machining material using lasers, i.e. in a laser machining system, the laser beam exiting a laser light source or one end of a laser fiber is focused or collimated onto the workpiece to be machined using beam guidance and focusing optics. Typically, a laser machining head including collimation optics and focusing optics is used, with the laser light being supplied via an optical fiber. The laser beam (i.e. the machining laser beam) can be directed to different positions on the workpiece using a scanner device. The scanner device usually comprises at least one scanning element, e.g. at least one scanning mirror that can be pivoted about one or two axes in order to deflect the laser beam. For process observation and/or process monitoring, a coaxial observation device, e.g. a camera, is also often used, the optical path of which runs at least partially coaxially or combined with that of the laser beam via the scanner device.

In conventional laser machining systems including a scanner device, e.g. an xy-galvo scanner device with two scanning elements, the focus position is determined by the scanner setting, i.e. by the angles of the scanning elements. The focus position generally exhibits a non-linear relationship to the angles of the scanning elements. This is mainly due to at least one of the following reasons: 1) The distance between the two scanning elements may cause a geometric, cushion-shaped distortion. 2) The focusing optics, e.g. an F-theta objective or an F-theta lens, may cause a barrel-shaped optical distortion. 3) Mechanical misalignment between the laser beam and the rotation axes of the scanning elements, for example when the laser beam hits one or both scanning elements outside the rotation axis thereof, and/or angular deviations of the scanning elements may also contribute to the non-linearity of the dependence of the focus position on the scanner setting. 4) In laser machining systems without encoder feedback, the non-linear relationship between the angle of the scanning element and the voltage applied to the galvanometer may cause a systematic offset. In laser machining systems with encoder feedback, systematic errors of the encoder may also cause distortions. 5) In addition, thermal effects may cause positional drift.

For low-accuracy applications, geometric and optical distortions according to 1) and 2) can be simulated using ray tracing software to determine a mapping between a position in a world coordinate system and the galvanometer angles or scanner setting required to deflect the laser beam to said position, i.e. between a world coordinate system and a scanner coordinate system. In reality, however, there is a discrepancy between simulation and actual results with a positioning error of approximately 500 μm and more, which makes this solution unsuitable for precision applications.

In addition, the same problems as for positioning the laser beam also occur for the coaxial observation device, which at least partially has the same optical path as the laser beam. It is well known that, due to the different wavelengths of the observation illumination and the laser beam, i.e. due to chromatic aberration, both subsystems, i.e. the scanner device and the observation device, must be calibrated separately. In addition, perspective distortions when the scanning field is viewed at different angles via the scanning elements and/or lens distortions due to lenses of the optical system of the observation device also occur in the observation device. Therefore, in order to measure a position on the workpiece, e.g. the focus position of the laser beam or the laser position, with the coaxial observation device, a non-linear relationship between the pixel coordinate system (also called image coordinate system or camera coordinate system) and the world coordinate system (also called reference coordinate system or calibration coordinate system) has to be established. In other words, for a given scanner setting (e.g. galvanometer angles α and β), it has to be determined which pixel coordinates in the image of the observation device (or which pixel of the camera) corresponds to a position x, y in the world coordinate system.

Finally, the question remains as to what the world coordinate system actually is and how the observation system, in particular the observation device, and the laser system, in particular the scanner device, can be calibrated to the same world coordinate system in order to synchronize both systems with each other. Unfortunately, there are several approaches to solving this coordination problem, which makes a comparison or evaluation of the different solutions difficult. For this reason, in the present disclosure, the task is defined as follows: 1) determining a mapping or function between the (reference) world coordinate system and the galvanometer angles for the laser beam (i.e. the scanner setting or the scanner coordinate system) or between the (reference) world coordinate system and the scanner coordinate system, and 2) determining a mapping or function between the (reference) world coordinate system and the pixel coordinate system. This splits the problem of observation and scanner coordinates into two separate partial problems in order to evaluate the results independently by comparing the actual position of the laser beam or the measurement position in the image with a reference.

U.S. Pat. No. 5,430,666 relates to an automated method and device for laser scanning calibration in a laser sintering device. EP 3 046 747 relates to a system and method for calibrating a laser scanning system. In both documents, a so-called “mark and measure” method is used in which a calibration plate or calibration sheet is marked with the laser beam and then measured with a scanner device or an external camera.

In scanner laser machining systems with a coaxial observation device, in which the observation device is used, for example, to position the laser beam, both the scanner device and the observation device have to be calibrated. When the scanner device is calibrated first using an external instrument, the observation device is to be calibrated using the same reference, e.g. a calibration plate, as used to calibrate the scanner device. This requires the calibration plate to be perfectly aligned with the axes of the scanner device and the working distance to be set precisely, which is difficult in practice. Even slight deviations in the length reference or in the pattern recognition algorithm may cause systematic errors. Another difficulty is that both the calibration of the scanner device and the calibration of the observation device are carried out during initial operation of the laser machining system at a customer. Calibration using a flatbed scanner device is usually not an option due to the high amount of time required or the lack of a suitable instrument.

### SUMMARY OF THE INVENTION

It is an object of the present invention to provide a method for calibrating a scanner device, in particular an xy-galvo scanner device, for a laser machining system that does not require any external instruments, and a laser machining system that comprises a scanner device and is configured to carry out said method.

It is in particular an object of the present invention to provide a method for calibrating a scanner device, in particular an xy-galvo scanner device, for a laser machining system, and a laser machining system that comprises a scanner device and is configured to carry out said method, wherein a reference is established between a non-linear scanner coordinate system or a non-linear behavior of the scanner settings for deflecting the laser beam on a linear reference or world coordinate system, in particular when the scanner device has not been calibrated by the manufacturer or has not been calibrated with sufficient accuracy.

It is a further object of the present invention to provide a method for calibrating a scanner device, in particular an xy-galvo scanner device, and for calibrating a coaxial observation device for a laser machining system, and a laser machining system that comprises a scanner device and a coaxial observation device and is configured to carry out said method.

It is in particular an object of the present invention to provide a method for calibrating a scanner device, in particular an xy-galvo scanner device, and for calibrating a coaxial observation device for a laser machining system, and a laser machining system that comprises a scanner device and a coaxial observation device and is configured to carry out said method, wherein an accurate synchronization or coordination of the observation coordinate system and the scanner coordinate system or the scanner settings for deflecting the laser beam is performed.

At least one of these objects is achieved by the subject matter disclosed herein.

The present invention is based on the idea of determining a relationship between a world coordinate system and scanner settings (e.g. angles of galvanometer mirrors) using a coaxial observation device included in the laser machining system. The use of external measuring devices is therefore not necessary. Furthermore, the coaxial observation device and the scanner device may be calibrated to the same reference or with respect to the same calibration plate, so that both calibrations use the same length reference. In addition, both calibrations may use the same pattern recognition algorithm.

According to one aspect of the present invention, a method for calibrating a laser machining system including a scanner device for deflecting a laser beam to a plurality of positions on a surface (e.g. a workpiece and/or a calibration plate) and including an observation device, the observation beam path of which runs coaxially to the laser beam path via the scanner device, comprises calibrating the scanner device with the steps of: generating laser markings on a calibration plate with a plurality of predetermined scanner settings; capturing an image of the calibration plate and of a calibration pattern having periodically arranged pattern cells by means of the observation device and determining a marking position of at least one of the laser markings on the calibration plate with respect to the calibration pattern in each image (in particular with respect to a pattern cell containing the respective laser marking); and determining scanner calibration data for each of the predetermined scanner settings based on the determined marking positions in order to assign a position, in particular a position of the laser beam at the respective scanner setting, in world coordinates to the predetermined scanner settings.

According to one aspect of the present invention, a method for calibrating a laser machining system including a scanner device for deflecting a laser beam to a plurality of positions on a surface (e.g. a workpiece and/or a calibration plate) and including an observation device, the observation beam path of which runs coaxially to the laser beam path via the scanner device, comprises calibrating the scanner device with the steps of: generating laser markings on a calibration plate with a plurality of predetermined scanner settings, the calibration plate having a calibration pattern with periodically arranged pattern cells; capturing one image of the calibration plate with each of the predetermined scanner settings by means of the observation device and determining a marking position of the respective laser marking on the calibration plate with respect to the calibration pattern in each image (in particular with respect to a pattern cell containing the respective laser marking); and determining scanner calibration data for each of the predetermined scanner settings based on the determined marking positions in order to assign a position, in particular a position of the laser beam at the respective scanner setting, in world coordinates to the predetermined scanner settings.

According to the present disclosure, a scanner device of a laser machining system is therefore calibrated using a coaxial observation device of the laser machining system and a calibration plate having a calibration pattern without external measurement instruments.

According to a further aspect of the present disclosure, a laser machining system for machining a workpiece using a laser beam comprises: a scanner device for deflecting the laser beam to a plurality of positions on a surface; an observation device, the observation beam of which path runs coaxially to the laser beam path via the scanner device; and a control configured to carry out a method for calibrating the laser machining system according to one of the aspects and/or embodiments described in this disclosure.

The method for calibrating a laser machining system and/or the laser machining system according to one of these aspects may comprise at least one or more of the following features:

The scanner device may be an xy-galvanometer scanner device including at least one deflectable scanning element (such as a scanning mirror), in particular including two deflectable scanning elements. Angle settings of the at least one scanning element may also be referred to as scanner settings. The scanner setting for a specific deflection of the laser beam may be two-dimensional, i.e. comprise two values, for example a first value for setting the first scanning element and a second value for setting the second scanning element. In other words, the scanner device may be configured to deflect the laser beam in two different directions (i.e. forming an angle with each other). The scanner setting may specify a deflection of the laser beam and/or a position of the laser beam (laser position) on a surface. The scanner device may be configured to deflect the laser beam within a predetermined scanning field. The scanning field is therefore an area into which the laser beam can be directed by means of the scanner device. The scanning field may have a size of ≥100 mm×≥100 mm, or ≥200 mm×≥200 mm, or ≥250 mm×≥250 mm. The scanning field does not have to be square.

According to the method according to the invention, each of the predetermined scanner settings may be assigned a position in world coordinates. The position in world coordinates may be a position of the laser beam at the respective scanner setting on the surface and/or on the calibration plate. The position in world coordinates may in particular be a position of the laser beam that the laser beam assumes on the surface and/or on the calibration plate at a predetermined (working) distance, i.e. distance from the surface or calibration plate, at the respective scanner setting.

The world coordinate system may be defined with respect to the calibration plate and/or with respect to the laser machining system (or a component thereof). The calibration pattern may define the world coordinate system.

The observation device may be a camera, a CCD camera, a grayscale camera, or the like. The observation device may be configured to capture a two-dimensional image of the calibration plate, in particular of the calibration pattern. The observation device may have an image field that is smaller than or equal to the scanning field of the scanner device. In the present disclosure, an observation device, the observation beam path of which runs at least partially coaxially with the laser beam path of the laser machining system, is also referred to as a coaxial observation device. The observation beam path of the observation device is coupled into the beam path of the laser beam, for example by a beam splitter, in front of the scanner device (i.e. in the propagation direction of the laser beam in front of the scanner device). The observation beam path of the observation device thus runs over/via the scanner device.

The calibration plate may be or comprise a metal plate or thermal paper. The calibration plate may have the calibration pattern, i.e. the calibration pattern may be applied, marked, burned in or the like on the calibration plate. The laser markings may be generated on the calibration plate having the calibration pattern. Alternatively, after the laser markings have been generated, a transparent film having the calibration pattern may be arranged on the calibration plate. For example, the calibration pattern may be printed on the film. The calibration plate and/or the calibration pattern may cover the entire scanning field. The laser marking may be an optically recognizable marking using the laser beam, e.g. a burn mark or the like

The calibration pattern includes a plurality of periodically arranged pattern cells. The pattern cells may have a square, triangular or quadrangular outline. The individual pattern cells may be identical to one another. A world coordinate system may be defined by the calibration pattern. The calibration pattern may comprise a grid pattern or a checkerboard pattern. The pattern cells may therefore form a grid pattern or a checkerboard pattern. A checkerboard pattern has the advantage that the laser markings for contrast optimization can be generated on the black pattern cells and/or on the white pattern cells. On the other hand, a checkerboard pattern can be easily recognized with high accuracy and reliability. In a checkerboard pattern, a pattern cell may be defined such that it comprises two black fields arranged diagonally to one another and two white fields arranged diagonally to one another.

The pattern cells are arranged periodically, i.e. at a predetermined period, in the calibration pattern. In other words, a pattern cell is periodically repeated in the calibration pattern. In the calibration pattern, the pattern cells may be arranged in a first direction (x-direction) at a predetermined first period (or x-period) and/or in a second direction (y-direction) at a predetermined second period (or y-period). The period of the calibration pattern and/or a size of the pattern cells is preferably large enough that the laser markings can be generated for the entire scanning field in one pattern cell even with the uncalibrated scanner device and/or when the calibration plate is incorrectly aligned. On the other hand, the size of the pattern cells is preferably small enough that local non-linearities and/or an optical distortion of the image field of the observation device can be detected during calibration, and/or that a plurality of periods of the calibration pattern are in the image field. For example, the size of each pattern cell may be 5 mm².

The laser markings may be generated line by row. A laser marking may be generated in each pattern cell. The laser markings may be generated at regular intervals. For example, the laser markings may be generated at a distance of 10 mm, e.g. in a black field of the pattern cell in the case of a checkerboard pattern. The laser markings may be generated in a first and/or a second direction at regular intervals, wherein the first and second directions may be perpendicular to one another.

A pattern cell that corresponds to a position of the laser beam at a certain scanner setting or in which a laser marking would be generated at a certain scanner setting may also be referred to as a target pattern cell.

The pattern cells corresponding to the predetermined scanner settings, i.e. the so-called target pattern cells, may be evenly distributed throughout the entire scanning field. In this way, it can be ensured that the entire scanning field is covered or that the calibration is carried out for the entire scanning field. The laser markings may be generated in every pattern cell within the scan field at the predetermined scanner settings. In other words, the predetermined scanner settings may correspond to all pattern cells within the scanning field. In this case, the calibration is carried out with a particularly high resolution or precision.

The predetermined scanner settings may be selected such that each of the predetermined scanner settings corresponds to a different pattern cell. In other words, the predetermined scanner settings may be selected such that a laser marking is generated in a different pattern cell at each of the predetermined scanner settings.

When calibrating the scanner device, generating the laser marking and capturing the image for determining the marking position of said laser marking is preferably carried out with the same scanner setting. In other words, the observation device may capture an image of the calibration plate at each of the predetermined scanner settings, i.e. at each scanner setting used to generate the laser markings. Alternatively, the marking positions of a plurality of laser markings may also be determined simultaneously, for example when they can be seen simultaneously in a captured image.

The marking position of the respective laser marking on the calibration plate may be determined with respect to the pattern cell in which the respective laser marking is located, in particular with respect to a pattern feature of the pattern cell, for example with respect to at least one corner, at least one edge and/or a center point of the pattern cell. To determine the marking position in the image, in particular a pixel position of the laser marking may be compared with a pixel position of at least one pattern feature of a pattern cell in which the laser marking is located in order to calculate a marking position in world coordinates and/or a relative offset of the marking position to the target position for the respective scanner setting. The at least one pattern feature of the pattern cell for determining the marking position may comprise at least one edge, at least one corner and/or a center point of the pattern cell.

The scanner calibration data may be based on the determined marking positions and the respective scanner settings. The scanner calibration data may include a correction table or a lookup table in which positions in world coordinates or positions of the laser beam in world coordinates and the associated scanner settings are listed. In other words, the scanner calibration data may include a list of marking positions in world coordinates and the respective scanner settings. The scanner calibration data may include a correction file consisting of parameters of a mathematical model that describes the relationship between positions in the world coordinate system and the corresponding scanner settings. The scanner calibration data may be used to determine a position of the laser beam in world coordinates for a certain scanner setting. The scanner calibration data may additionally or alternatively include a list of offset vectors in world coordinates and the respective scanner settings, the offset vectors each specifying an offset between the determined marking position and a theoretical position of the laser marking corresponding to the respective scanner setting.

When calibrating the scanner device, in a first step the laser markings may be generated at all of the predetermined scanner settings, and in a second step all of the images may be captured at all of the predetermined scanner settings. The scanner settings for generating the laser markings and the scanner settings for capturing the images to determine the marking positions are preferably identical. Alternatively, in a first step a laser marking may be generated at each of the predetermined scanner settings and an image may be captured in a second step, and these two steps may be repeated for all of the predetermined scanner settings. In other words, a laser marking may be generated and an image may be captured at one of the predetermined scanner settings, and then another laser marking may be generated and another image may be captured at another of the predetermined scanner settings until a laser marking has been generated and an image has been captured for all of the predetermined scanner settings.

Calibrating the scanner device may further comprise verifying the scanner calibration data. Verifying the scanner calibration data may comprise the steps of: generating a verification laser marking on the calibration plate at a scanner setting corrected based on the scanner calibration data, which corresponds to a predetermined position (e.g. in world coordinates and/or with respect to the target pattern cell) in a target pattern cell; capturing an image of the calibration plate at the corrected scanner setting by means of the observation device and determining a marking position of the verification laser marking on the calibration plate (e.g. in world coordinates and/or with respect to the target pattern cell); and comparing the determined marking position with the predetermined position. For example, the predetermined position in the target pattern cell may be the center of the target pattern cell. In the captured image, it may be checked whether the marking position of the verification laser marking corresponds to the center of the target pattern cell. The steps for verifying the scanner calibration data may be carried out for a plurality of target pattern cells. Target pattern cell may refer to a pattern cell of the calibration pattern in which the specified position is located. In other words, in order to verify the scanner calibration, a position may be specified for each of the plurality of target pattern cells in world coordinates. Based on the scanner calibration data, a corrected scanner setting may be determined for each of these positions in order to generate a verification laser marking on the calibration plate at this corrected scanner setting. An image may then be captured using the observation device at each of these corrected scanner settings and a marking position of the verification laser marking may be determined in world coordinates and/or with respect to the target pattern cell. The determined marking position of the verification laser marking may be compared with the specified position. If both positions match, the scanner calibration data may be considered verified. Here too, generating the verification laser marking and capturing the image for determining the marking position may be carried out at the same corrected scanner setting. The predetermined position in the target pattern cell may correspond to a feature of the target pattern cell, e.g. the center, a corner, etc. The predetermined position may be the same for each target pattern cell.

The method for calibrating the laser machining system may further comprise calibrating the observation device with the steps of: determining a position of a feature of a first target pattern cell in a first image of the calibration plate (e.g. in pixel coordinates), captured at a first scanner setting corresponding to the first target pattern cell, and determining a position of a (preferably matching) feature of a second target pattern cell in a second image of the calibration plate (e.g. in pixel coordinates), captured at a second scanner setting that is shifted with respect to the first scanner setting an corresponds to the second target pattern cell, respectively for a plurality of first and second scanner settings; determining a feature shift (e.g. in pixel coordinates) by comparing the position of the feature of the first target pattern cell in the first image with a position of the (preferably matching) feature of the second target pattern cell in the second image taking into account the shift between the first and second scanner settings and a period of the calibration pattern, respectively for the plurality of first and second scanner settings; and determining image calibration data for correcting the chromatic aberration for each of the first scanner settings based on the determined feature shifts.

In this way, it can be ensured that the observation device and the scanner device are calibrated with respect to the same reference system, i.e. the world coordinate system of the calibration plate. In addition, when calibrating the observation device, the same calibration plate and/or the same pattern recognition algorithm for recognizing features of the calibration pattern, i.e. features of the pattern cells, may be used as when calibrating the scanner device. After correcting the chromatic aberration, the target pattern cell should be in the center of the corresponding image (i.e. the image captured at the scanner setting corresponding to the target pattern cell). Due to chromatic aberration, a shift of the pattern cells in pixel coordinates may occur depending on the scanner settings. It is to be noted here that optical elements of a laser machining system systems are usually optimized for the wavelength of the laser beam, so that optical errors occur for visible light.

In other words, a position in world coordinates in the image may be shifted as a function of the scanner setting when the image is captured. Thus, calibration of the observation device may be necessary to correct the chromatic aberration in order to assign a position in pixel coordinates (i.e. a position in the image) to a position in world coordinates (i.e. a position on the calibration plate or on the surface). A position in pixel coordinates may also be referred to as a pixel position.

Calibrating the observation device may therefore be carried out without radiating the laser beam. When calibrating the observation device, two images captured by the observation device at different scanner settings may be compared.

A scanner setting corresponding to a target pattern cell, on the other hand, may refer to a scanner setting in which the laser beam would be in this pattern cell. A feature of the first or second target pattern cell may be a pattern feature, e.g. an edge, a corner, a center point of the first or second target pattern cell, and/or a laser marking in the target pattern cell, in particular a verification laser marking. The feature of the first target pattern cell may correspond to the feature of the second target pattern cell, i.e. the features may each be a specific corner of the target pattern cell or the center point.

Determining the position of the feature of the target pattern cell in the image may yield a position in pixel coordinates. The feature shift may also be specified in pixel coordinates. When the features of the first and second target pattern cells correspond to one another and the shift between the first and second scanner settings corresponds to an integer multiple of the period of the calibration pattern, the positions of the features in the first and second image should be identical, i.e. there should be no feature shift or the feature shift should be zero.

The second scanner setting may be shifted by at least one period of the calibration pattern with respect to the first scanner setting. In other words, the shift between the first and second scanner settings may correspond to a shift by at least one period of the calibration pattern. Preferably, the first target pattern cell and the second target pattern cell are consecutive pattern cells of the calibration pattern. The first target pattern cell and the second target pattern cell may therefore be adjacent or directly adjacent to one another.

The first scanner setting and the second scanner setting or the first target pattern cell and the second target pattern cell or the first image and the second image may each be referred to as a comparison pair of scanner settings or target pattern cells or images for determining the feature shift. Determining the feature shift may be carried out for a plurality of comparison pairs. The first scanner settings of the plurality of first scanner settings may be shifted, e.g. by row, from one target pattern cell to the next target pattern cell.

The first scanner settings and the second scanner settings may be included in the predetermined scanner settings for calibrating the scanner device. In this case, the first and second images may be images that have been captured for calibrating the scanner device, in particular for determining marking positions of the laser markings. The first and second images may also be images that have been captured for verifying the scanner calibration data. Here, center points of the target pattern cells may then preferably be used as features of the first and second target pattern cells. The feature shift may be defined by a shift vector in pixel coordinates. The feature shift may be defined as a deviation of the position of the feature of the second target pattern cell in the second image from a theoretical position of the feature of the second target pattern cell to be expected based on the shift between the first and second scanner settings and a period of the calibration pattern.

Based on the feature shifts determined for the plurality of first and second scanner settings (or for the plurality of comparison pairs of scanner settings), image calibration data for correcting the chromatic aberration may be determined for each of the first and/or second scanner settings. The image calibration data may be based on the determined feature shifts and the respective scanner settings. The image calibration data may therefore specify, for each scanner setting, a corresponding pixel position which corresponds to a position of the laser beam and/or a position of a feature (e.g. the center point) of the target pattern cell in the image for this scanner setting. The image calibration data may include a list of scanner settings and corresponding pixel positions. The image calibration data may include a correction table or a lookup table, in which, for the respective scanner settings, positions in world coordinates or positions of the laser beam in world coordinates are assigned to corresponding pixel positions in the images captured at the respective scanner settings. The image calibration data may be used to assign a position of the laser beam in an image, i.e. a pixel position of the laser beam in pixel coordinates, to a position of the laser beam in world coordinates for a specific scanner setting. This enables error-free process observation and/or process guidance.

The image calibration data for correcting the chromatic aberration may include a list of positions in world coordinates corresponding to the scanner settings and of the feature shifts in pixel coordinates determined for the first scanner settings.

The image calibration data for correcting the chromatic aberration may include a list of shift vectors in pixel coordinates and respective positions in world coordinates corresponding to the scanner settings. The shift vectors may each indicate a deviation of the position of the feature of the second target pattern cell in the second image from a theoretical position of the feature of the second target pattern cell to be expected based on the shift between the first and second scanner settings and a period of the calibration pattern.

The feature for determining the marking position when calibrating the scanner device may be the same as or different from the feature for determining the feature shift when calibrating the observation device.

The calibration of the observation device may comprise, for each of the plurality of first and second scanner settings: capturing the first image of the calibration plate at the first scanner setting corresponding to the first target pattern cell and capturing the second image of the calibration plate at the second scanner setting that is shifted with respect to the first scanner setting an corresponds to the second target pattern cell, wherein the first and second scanner settings are corrected based on the scanner calibration data. Alternatively, the plurality of first and second scanner settings may be included in the plurality of predetermined scanner settings for calibrating the scanner device, and/or the first and second images may each be an image captured for calibrating the scanner device at the corresponding scanner setting. When determining the feature shift, the scanner calibration data may then be additionally taken into account.

Calibrating the observation device may further comprise an image distortion correction. The image distortion correction may comprise the following steps for some or all of the first and/or second images: correcting the image based on the image calibration data to correct the chromatic aberration according to the scanner setting when the image was captured; determining pixel positions of at least one feature of a plurality of (or all) pattern cells in the corrected image; and creating an image distortion correction model based on a comparison of pixel distances between the determined pixel positions and corresponding distances of the respective features on the calibration plate in world coordinates for the respective scanner setting when the image was captured. For example, when a checkerboard pattern is used as the calibration pattern, the pixel positions of all corners in the image may be determined and a model for image distortion correction may be created based thereon and based on the known corner distance in the world coordinate system (i.e. on the calibration plate).

The control of the laser machining system may be configured to control the scanner device and/or the observation device. The control of the laser machining system may be configured to carry out an image analysis on the images captured by the observation device, e.g. by applying a pattern recognition algorithm.

The laser machining system may further comprise a focusing optics, in particular an F Theta objective or F-Theta lens, for focusing the laser beam. The focusing optics may be arranged after the scanner device (with respect to the beam propagation direction of the laser beam).

The laser machining system may be a laser machining system for carrying out a machining process, in particular for laser cutting, laser welding, laser soldering, laser drilling, etc., on the workpiece by means of the laser beam.

The workpiece may in particular be a metallic workpiece. The laser machining system may be configured to machine a metallic workpiece.

### BRIEF DESCRIPTION OF THE DRAWINGS

Embodiments of the disclosure are shown in the Figs. and are described in more detail below. In the figures:

FIG. 1 is a schematic diagram of a laser machining system for laser machining a workpiece using a laser beam according to embodiments of the invention;

FIG. 2 shows a schematic diagram of the various coordinate systems of a laser machining system to be synchronized with one another according to embodiments of the invention;

FIGS. 3A and 3B show exemplary embodiments of a calibration pattern of a calibration plate according to embodiments of the invention;

FIGS. 4A and 4B show flow charts of a method for calibrating the scanner device according to embodiments of the invention;

FIGS. 5A and 5B show flow charts of a verification of the calibration of the scanner device according to embodiments of the invention;

FIG. 6 shows a flow chart of a method for calibrating the coaxial observation device for correcting chromatic aberration according to embodiments of the invention.

FIG. 7 shows a flow chart of a method for calibrating the coaxial observation device for image distortion correction according to embodiments of the invention; and

FIG. 8 shows a flow chart of a method for calibrating the scanner device and for calibrating the coaxial observation device according to embodiments of the invention.

### DETAILED DESCRIPTION OF THE DRAWINGS

Hereinafter, unless otherwise stated, the same reference symbols are used for identical elements and elements with identical effect.

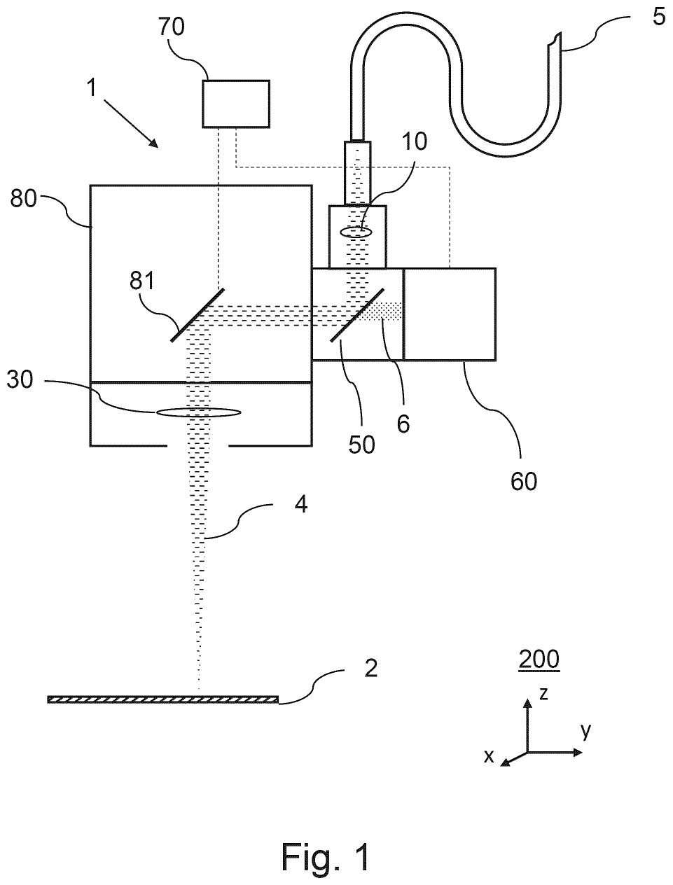

FIG. 1 shows a schematic diagram of a laser machining system 1 according to embodiments of the present disclosure.

The laser machining system 1 comprises a scanner device 80 including one or two scanning elements 81 for deflecting the laser beam 4 to a plurality of positions on a surface 2, for example a workpiece to be machined, and an observation device 60, the observation beam path 6 of which runs at least partially coaxially with the beam path of the laser beam 4. The observation device 60 may be or comprise a camera, in particular a grayscale camera or a CCD camera. The laser beam path 4 and the observation beam path 6 may be coupled by means of a beam coupling element 50, such as by means of a beam combiner, a dichroic mirror, etc. The coupling of the two beam paths 4 and 6 takes place in front of the scanner device 80 (in the beam propagation direction of the laser beam 4) or between the scanner device 80 and the observation device 60. Thus, both the laser beam path 4 and the observation beam path 6 run over the scanner device 80. The image field of the observation device 60 is thus aligned or deflected on the surface according to a scanner setting, i.e. a setting of the at least one scanning element 81. The image field of the observation device 60 contains a point of incidence of the laser beam 4 on the surface 2.

The laser machining system 1 further comprises a control 70. The control 70 may be configured to control the scanner device 80, in particular based on a scanner setting for positioning the laser beam 4 for laser machining, and/or to control the observation device 60 for capturing or recording an image. The control 70 may further be configured to receive an image of the surface 2 captured by the observation device 60. The control 70 may be configured to control a laser source for radiating the laser beam 4.

The scanner device 80 may be a 1D or 2D galvanometer scanner. The scanner device 80 may comprise exactly one scanning element 81, e.g. a scanning mirror, which can be rotated or pivoted about an axis in order to deflect the laser beam 4 on the surface 2. The scanning element may also be rotatable or pivotable about two different axes in order to deflect the laser beam 4 in two different directions, for example in two orthogonal directions x and y, on the surface 2. Although it is not shown in FIG. 1, the scanner device 80 preferably comprises two scanning elements 81 or scanning mirrors, each of which can be rotated or pivoted about an axis in order to deflect the laser beam 4 in two different directions, for example in two orthogonal directions x and y, on the surface 2. The control 70 may be configured to adjust the scanner device 80 according to a scanner setting, for example an angle pair (α, β). The scanner setting can be considered to be a position in a scanner coordinate system.

The laser machining system 1 may further comprise collimation optics 10 for collimating the laser beam 4 entering the laser machining system 1 divergently, and focusing optics 30, for example an F-theta lens, for focusing the laser beam 4 with respect to the surface 2. In particular, the laser beam 4 exiting a laser light source or an end of a laser guide fiber 5 may be focused or collimated using the collimation optics 10 and the focusing optics 30 on a surface of a workpiece 2 to be machined in order to thereby carry out a machining operation or a machining process. Machining may include, for example, laser cutting, soldering, welding or drilling.

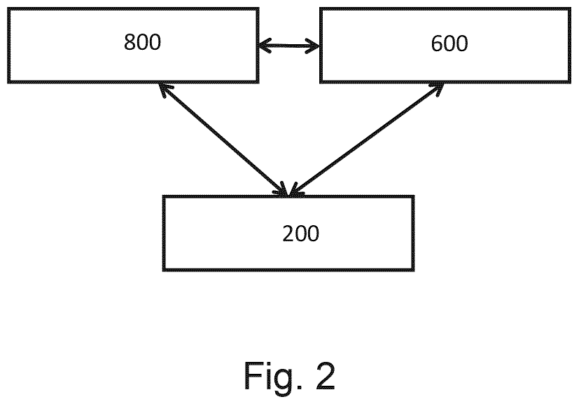

In a laser machining system 1 including a scanner device 80 and a coaxially mounted observation device 60, the position of the laser beam 4 and the scanner setting are correlated non-linearly with one another. Therefore, a calibration of the scanner device 80 or a synchronization of a scanner coordinate system 800 with a world coordinate system 200, i.e. with the spatial coordinates x, y, z of the machining area, is required. Likewise, a pixel coordinate system of the observation device 60 with world coordinates of the surface 2 or a machining area are correlated non-linearly with one another. However, in order to use the observation device 60 to position the laser beam 4, both the scanner device 80 and the observation device 60 must be calibrated. Preferably, therefore, as shown in FIG. 2, a scanner coordinate system 800 and a pixel coordinate system 600 of the observation device 60 are synchronized with a world coordinate system 200, i.e. with the spatial coordinates x, y, z of the machining area.

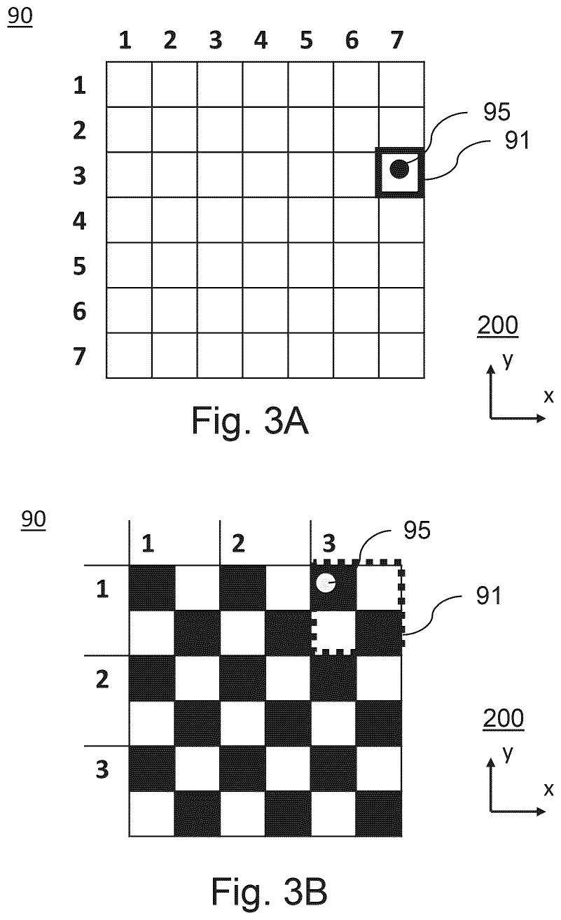

According to the present invention, a method for calibrating the scanner device 80 by means of a calibration plate 90 having a calibration pattern and the coaxial observation device 60 is proposed. Examples of a calibration plate 90 having different calibration patterns are shown in FIGS. 3A and 3B. The calibration pattern may consist of periodically arranged pattern cells 91 (highlighted in FIGS. 3A and 3B for illustration purposes). The calibration pattern may be defined with respect to the world coordinate system 200 or define the world coordinate system 200. The calibration pattern may be, for example, a grid, as shown in FIG. 3A, or a checkerboard pattern as shown in FIG. 3B. In a checkerboard pattern, a pattern cell 91 may consist of two diagonally arranged black and white fields. In order to optimize image contrast, a laser marking 95 may be generated either on the black fields or on the white fields of the calibration pattern.

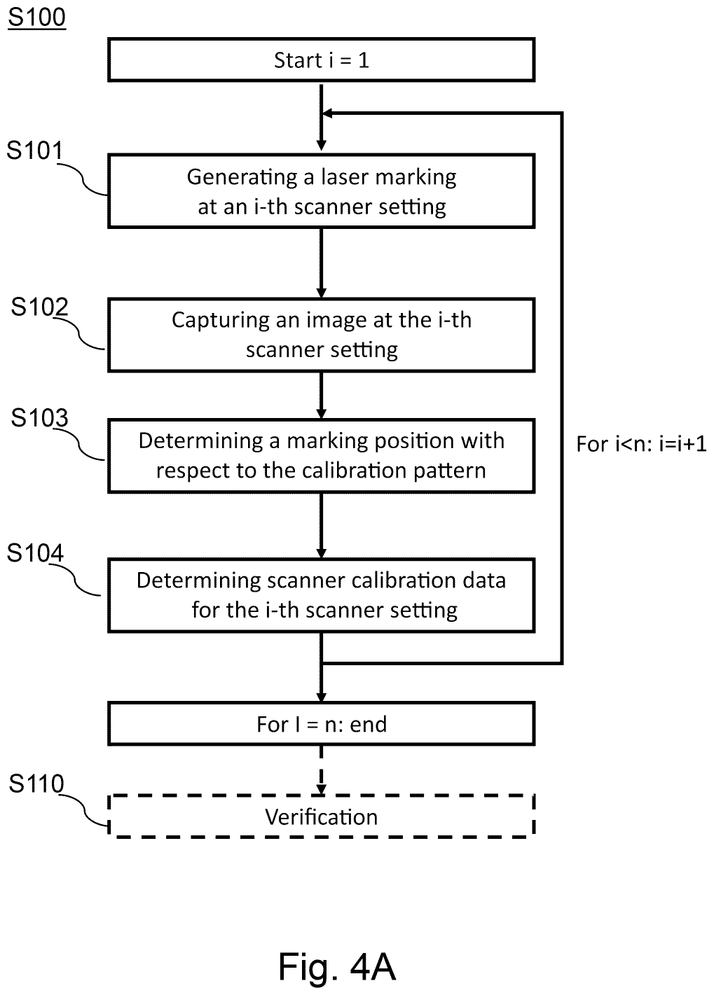

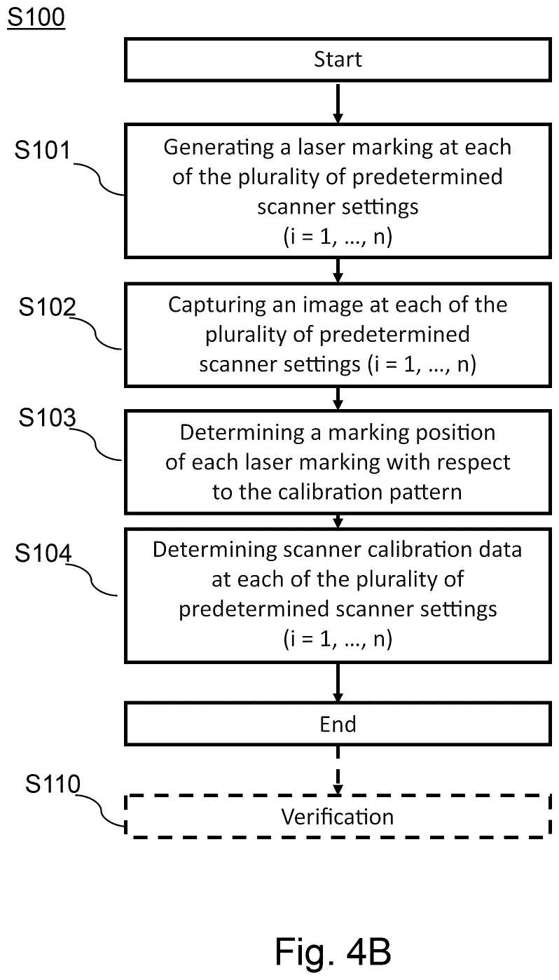

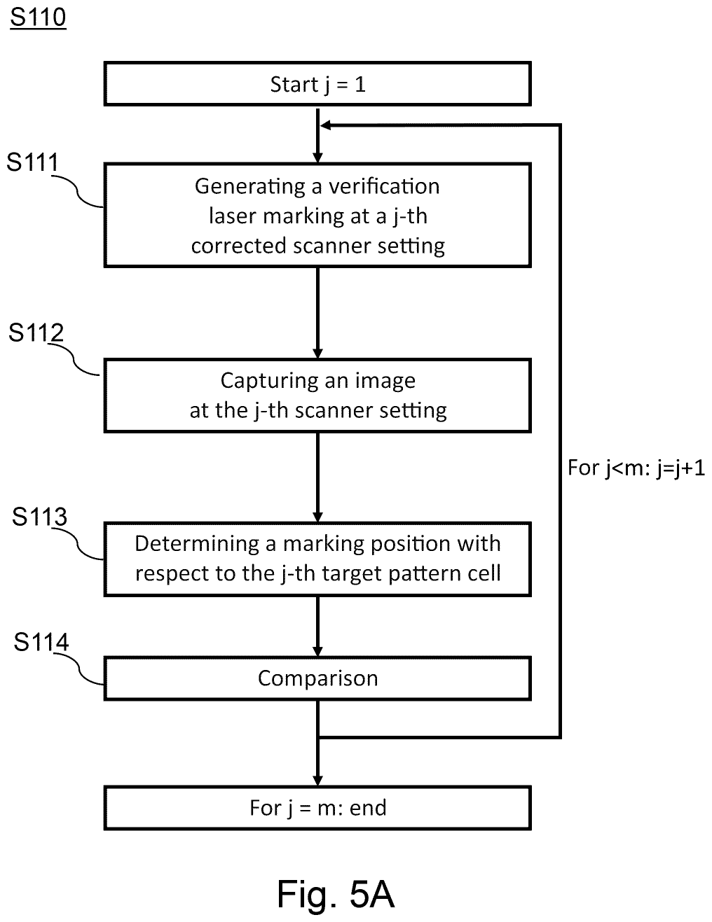

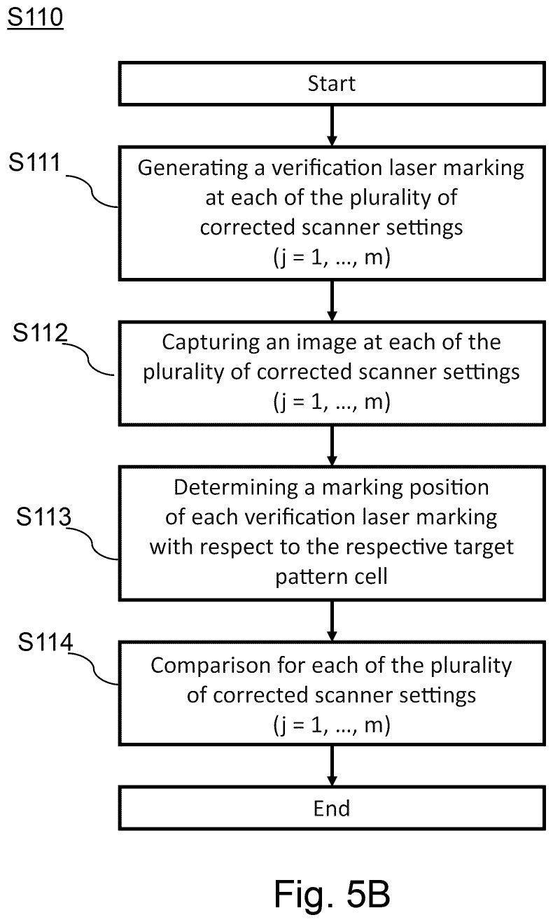

FIGS. 4A and 4B each show flow charts of a method S100 for calibrating the scanner device 80 according to embodiments of the present invention. First, according to the present invention, laser markings 95 are generated on the calibration plate 90 at a plurality of predetermined scanner settings (S101). The predetermined scanner settings may correspond to some or all of the pattern cells 91, so that a laser marking 95 is generated in some or all of the pattern cells 91. Preferably, for each of said predetermined scanner settings, an image of the calibration plate 90 is captured by the observation device 60 (S102), and, in the image, a marking position of the respective laser marking 95, i.e. the laser marking 95 generated at this scanner setting, on the calibration plate 90 is determined with respect to the calibration pattern (S103). Alternatively, an image of the calibration plate 90 may also be captured by the observation device 60 in order to determine marking positions of a plurality of laser markings 95 on the calibration plate 90 with respect to the calibration pattern. Based on the determined marking positions, scanner calibration data is determined for all of the predetermined scanner settings in order to be able to assign a position in the world coordinate system 200 to the predetermined scanner settings. Optionally, verification S110 of the scanner calibration data can be carried out, as described below with reference to FIG. 5.

The method of FIG. 4A differs from the method illustrated in FIG. 4B only in that for an i-th scanner setting of the predetermined scanner settings, both the laser mark is generated (S101) and the image is captured (S102) before these steps are repeated for an (i+1)-th scanner setting. As shown in FIG. 4A, step S103 of determining the marking position of the laser marking generated for this i-th scanner setting and optionally also step S104 of determining scanner calibration data for the i-th scanner setting may also be performed before the scanner setting is changed to the (i+1)-th scanner setting. Alternatively, as shown in FIG. 4B, all laser markings may first be generated for all of the predetermined scanner settings (S101) and then an image may be captured for each of the predetermined scanner settings (S102). In this case, each of the predetermined scanner settings is performed twice.

When determining S103 the marking position, a pixel position of the laser marking may be determined with respect to the calibration pattern in the respective image captured at the same scanner setting at which the laser marking 95 was also generated. In particular, a pixel position of the laser marking 95 may be compared with a pixel position of at least one pattern feature of a pattern cell 91 in which the laser marking is located in order to calculate a marking position in world coordinates for the respective scanner setting. Here, a pixel position refers to a position in an image captured by the observation device 60, i.e. a position in the pixel coordinate system. For example, a pattern feature may be at least one of: a center point of the pattern cell 91, a left upper corner of the pattern cell 91, a left lower corner of the pattern cell 91, a right upper corner of the pattern cell 91, a right lower corner of the pattern cell 91, a left edge of the pattern cell 91, a right edge of the pattern cell 91, an upper edge of the pattern cell 91, and a lower edge of the pattern cell 91. For example, after the laser marking 95 has been generated, the marking position may be determined by comparing the pixel position of the laser marking 95 with the pixel positions of the four corners surrounding the laser marking 95. Since the calibration pattern, in particular a size of the pattern cells 91 and/or a position of the pattern cell 91 in the world coordinate system 200, is known, the marking position in the world coordinate system 200 can be determined.

The scanner calibration data may include a list of marking positions in world coordinates and the respective scanner settings. From this information, which can be pre-processed if necessary, a correction file consisting of a lookup table of positions in world coordinates and corresponding scanner settings thereof can be created. Alternatively, a correction file may consist of parameters of a mathematical model that describes the relationship between positions in world coordinates and their corresponding scanner settings. The correction file may be stored, for example, in the control 70 for driving the scanner device 80.

FIGS. 5A and 5B show processes of verifying S110 the scanner calibration data according to embodiments of the invention, which may optionally be carried out after calibrating S100 the scanner device 80. Verifying S110 the scanner calibration data may include the steps of: generating a verification laser marking on the calibration plate 90 for a plurality of corrected scanner settings (S111). The corrected scanner settings are scanner settings that have been corrected based on the respective scanner calibration data. The corrected scanner settings correspond to a predetermined position in a target pattern cell, i.e. in the pattern cell 91 in which the verification laser marking is to be generated. For example, the corrected scanner settings may each correspond to a center point in the target pattern cells. The predetermined position in the target pattern cell may be predetermined relative to at least one pattern feature of the target pattern cell. At each of the plurality of corrected scanner settings, an image is also captured by means of the observation device 60 (S112) and a marking position of the verification laser marking with respect to the calibration pattern, in particular with respect to the pattern feature of the target pattern cell, is determined (S113). A pixel position of the verification laser marking in the respective image is then compared with the predetermined position in the target pattern cell (S114). Thus, based on the corresponding captured image, it can be checked whether a verification laser marking was actually generated at the predetermined position with a corrected scanner setting that corresponds, for example, to the center of a target pattern cell.

The process of verifying is illustrated in FIG. 5A according to FIG. 4A, wherein, for each of the corrected scanner settings, a verification laser marking is generated in a first step and an image is captured in a second step, and these two steps are repeated for all corrected scanner settings. However, during verification S110, as shown in FIG. 5B corresponding to FIG. 4B, the verification laser markings may also be generated for all corrected scanner settings in a first step and all images may be captured for all corrected scanner settings in a second step.

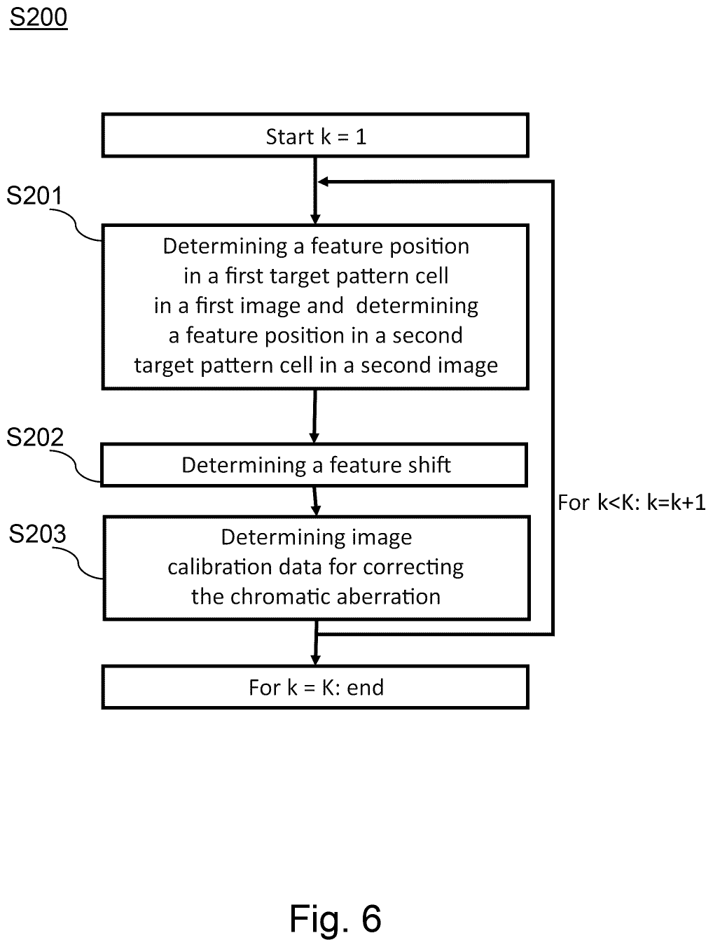

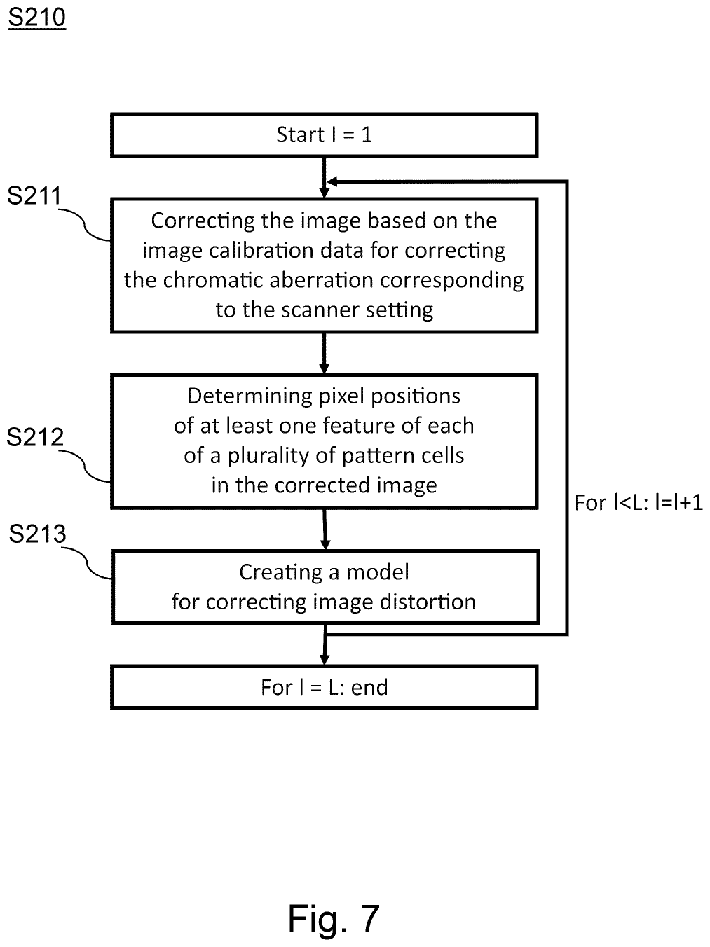

In addition, calibration of the observation device 60 may be necessary, for example to enable image-based positioning of the laser beam 4. The same calibration plate 90 and/or the same image analysis or pattern recognition algorithm as for calibrating the scanner device 80 may be used to calibrate the observation device 60. The effort may thus be kept on a low level. FIG. 6 shows a flow chart for calibrating the observation device 60 according to embodiments of the invention in order to correct a chromatic aberration as a function of the scanner setting. If the scanner device 80 were perfectly calibrated, the image of the calibration pattern would have to remain unchanged if the scanner setting was shifted by exactly one period of the calibration pattern. However, due to chromatic aberration, a slight image offset occurs so that the calibration pattern between the two images is no longer congruent. When calibrating the observation device 60 to correct the chromatic aberration, this offset can be recorded for each scanner setting.

For calibrating the observation device 60, a plurality of scanner settings may be divided into K comparison pairs, each including a first and a second scanner setting. The calibration of the scanner device 80 is already completed here, so that the first and second scanner settings are scanner settings corrected based on the scanner calibration data. For each of the comparison pairs of scanner settings, a position of a feature in a first target pattern cell corresponding to the first scanner setting of the comparison pair may be determined in a first image captured at said first scanner setting of the comparison pair, and a position of a feature in a second target pattern cell corresponding to the second scanner setting of the comparison pair may be determined in a second image captured at said second scanner setting of the comparison pair (S201). The first target pattern cell and the second target pattern cell may be adjacent pattern cells in the calibration pattern. In other words, the first scanner setting may be shifted with respect to the second scanner setting by one period of the calibration pattern. Subsequently, a feature shift from the first image to the second image may be determined for each of the comparison pairs of scanner settings (S202). Here, the pixel position of the feature of the first target pattern cell in the first image may be compared with the pixel position of the feature of the second target pattern cell in the second image, taking into account the shift between the first and second scanner settings and a period of the calibration pattern. Based on the feature shifts for the comparison pairs of scanner settings, image calibration data for correcting the chromatic aberration can be determined for the plurality of scanner settings (S203).

The feature of the first target pattern cell and the feature of the second target pattern cell may be the same, e.g. the center point of the target pattern cell in each case. The feature of the first target pattern cell and the feature of the second target pattern cell may be a pattern feature or also a verification laser marking in the target pattern cell if the specified positions of the verification laser markings in the respective target pattern cells are identical when verifying the scanner calibration data. In one example, the pixel positions of the center points of all target pattern cells of the scanner settings and displacement thereof with respect to a scanner setting corresponding to a zero position (undeflected laser beam) may be determined. The image calibration data for correcting chromatic aberration may include a list of positions in world coordinates corresponding to the scanner settings and of the feature displacements in pixel coordinates determined for the scanner settings. The list may be converted into a lookup table indicating the exact position of the laser beam 4 in pixel coordinates of the observation device 60 for a given scanner setting. Alternatively, the image calibration data for correcting chromatic aberration may include a list of displacement vectors in pixel coordinates and respective positions in world coordinates corresponding to the scanner settings, and the displacement vectors may each indicate a deviation of the position of the feature of the second target pattern cell in the second image from a theoretical position of the feature of the second target pattern cell expected based on the displacement between the first and second scanner settings and a period of the calibration pattern.

Calibrating the observation device 60 may include capturing the first and second images for the comparison pairs of scanner settings. Alternatively, the first and second images for the comparison pairs of scanner settings may be images captured for calibrating the scanner device 80. In this case, when determining S202 the feature shift, the corresponding scanner calibration data may also be taken into account in addition to the shift between the first and second scanner settings and the period of the calibration pattern.

In addition to chromatic aberration, other optical errors may occur that result in image distortion. Therefore, calibrating the observation device 60 may further include an image distortion correction S210 in order to correct, for example, scanner setting-dependent effects such as changes in the image scale, rotations, shear effects and radial lens distortion effects or the like for the entire scanning field.

The image distortion correction S210 may be performed on some or all of the first and/or second images for correcting the chromatic aberration. Preferably, the image distortion correction S210 is performed on images corresponding to a plurality of scanner settings distributed over the entire scanning field. Each image is first corrected based on the image calibration data for correcting the chromatic aberration according to the respective scanner setting at which the image was captured (S211). The pixel position of at least one feature is then determined for a plurality of pattern cells 91 (S212). For example, the pixel positions of all corners of all pattern cells 91 in the image may be determined. Based on the pixel positions and known distances of the features of the pattern cells in world coordinates, a model for image distortion correction may be created for the respective scanner setting at which the image was captured (S213). In this way, based on a distance between two pixel positions in an image, a relative position of the two pixel positions in the world coordinate system 200 can be determined using the model for image distortion correction.

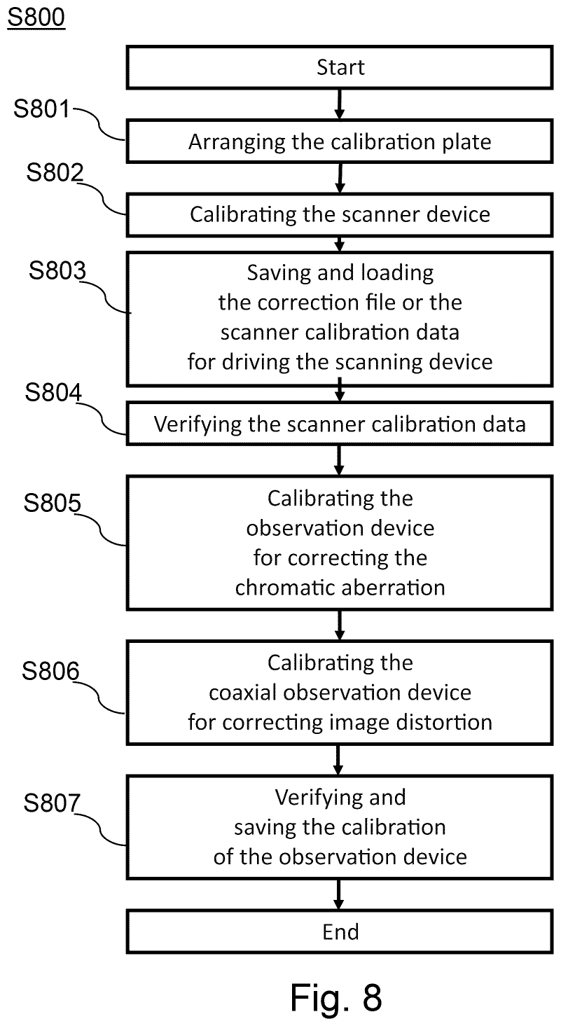

FIG. 8 shows an embodiment for the combined calibration S800 of a scanner device 80 and a coaxial observation device 60 of a laser machining system 1. In step S801, a calibration plate 90 may be arranged in the scanning field of the laser machining system 1 and aligned approximately to the axes of the scanner coordinate system 800. The calibration plate is preferably larger than the scanning field or covers it completely. The scanner device may then be calibrated in step S802, wherein laser markings 95 are generated on the calibration plate 80 and the position in world coordinates is determined for each laser marking using the coaxial observation device 60 and a calibration pattern of the calibration plate 90. A correction file including scanner calibration data is then generated, for example consisting of a lookup table with world coordinate positions and the corresponding scanner settings. As step S802, the method S100 shown in FIG. 4A or 4B for calibrating the scanner device 80 including steps S101 to S104 may also be carried out. In step S803, the correction file or the scanner calibration data is saved and loaded to drive the scanner device 80. In step S804, the calibration of the scanner device is verified by again generating laser markings on the same calibration plate 90. As step S804, the process S110 shown in FIG. 5A or 5B for verifying the scanner calibration data may also be carried out. In step S805, the same calibration plate 80 and the same pattern recognition algorithm (e.g., a corner and/or edge recognition algorithm) are used to calibrate the observation device for correcting chromatic aberration. For example, all corners of a target pattern cell may be detected for each scanner setting in the scanning field and a shift in the corner positions may be used to determine an offset of the chromatic aberration for each scanner setting. The offsets of the chromatic aberration are used to generate a lookup table or function of the scanner setting versus pixel offset. As step S805, the method S200 shown in FIG. 6 may also be carried out. In step S806, the coaxial observation device is calibrated for image distortion correction. By knowing the corner positions in pixel coordinates and the relative position in world coordinates, a model for image distortion correction that maps a relative position in pixel coordinates to a relative n position in world coordinates for a given scanner setting can be established. As step S806, the method S210 may be performed. In step S807, the calibration of the observation device may be verified and stored.

According to the present disclosure, a scanner device of a laser machining system may be calibrated using a calibration plate having a calibration pattern and a coaxial observation device integrated in the laser machining system without the aid of external measurement instruments. This can greatly increase the efficiency of the calibration and greatly reduce the cost of the calibration. Verifying the calibration may be carried out easily and immediately subsequent to the calibration.

In addition, the same setup may be used to calibrate the coaxial observation device to correct chromatic aberration and/or to correct image distortions. Calibrating two systems or devices to the same reference is generally much more important than calibrating them to an absolute reference. This leads to lower requirements for the calibration plate and for an alignment process when they are arranged. In particular, according to the present disclosure, the coaxial observation device may be calibrated to the same reference as the scanner device, so that both calibrations can use the same detection algorithm or pattern recognition algorithm and the same length reference. Furthermore, since the observation device and the scanner device are calibrated with the same reference, slight scaling errors in the calibration plate are tolerated better compared to calibrating the two devices separately using different methods. In addition, calibrating the scanner device and/or the observation device may be automated, with the exception of the one-time arrangement of the calibration plate.

### LIST OF REFERENCE SYMBOLS

1 Laser machining system
2 Surface (workpiece, calibration plate)
3 Laser beam
4 Laser optical fiber
5 Observation beam path
10 Collimation optics
50 Beam coupling element
30 Focusing optics
60 Observation device
70 Control
80 Scanner device
81 Scanning element
90 Calibration plate
91 Pattern cell
95 Laser marking
200 World coordinate system
600 Pixel coordinate system
800 Scanner coordinate system

1. A method for calibrating a laser machining system including a scanner device for deflecting a laser beam to a plurality of positions on a surface and including an observation device, an observation beam path of which runs at least partially coaxially with the laser beam path and over said scanner device, comprising calibrating said scanner device with the steps of:
generating laser markings on a calibration plate at a plurality of predetermined scanner settings;
capturing an image respectively of said calibration plate and of a calibration pattern on said calibration plate, the calibration pattern having periodically arranged pattern cells, by means of said observation device and determining a marking position of at least one of the laser markings on said calibration plate with respect to the calibration pattern in each image; and
determining scanner calibration data for each of the predetermined scanner settings based on the determined marking positions in order to assign a position in a world coordinate system to the predetermined scanner settings.

2. The method according to claim 1, wherein the laser markings are generated on said calibration plate with the calibration pattern; or
wherein, after generating the laser markings on said calibration plate, a transparent film with the calibration pattern is arranged on said calibration plate.

3. The method according to claim 1, wherein, when calibrating said scanner device:
at each of the predetermined scanner settings, an image of said calibration plate is captured and a marking position of the respective laser marking generated at said scanner settings on said calibration plate is determined with respect to the calibration pattern in each image; and/or
in a first step, the laser markings are generated at all predetermined scanner settings, and in a second step, all images are captured at all predetermined scanner settings, or
at each of the predetermined scanner settings, a laser marking is generated in a first step and an image is captured in a second step, and these two steps are repeated for all predetermined scanner settings.

4. The method according to claim 1, wherein, in order to determine the marking position in the image, a pixel position of the laser marking is compared with a pixel position of at least one pattern feature of a pattern cell, in which the laser marking is located, in order to calculate a marking position in said world coordinate system for the respective scanner setting.

5. The method according to claim 4, wherein the at least one pattern feature of the pattern cell for determining the marking position comprises at least one edge, at least one corner, and/or a center point of the pattern cell.

6. The method according to claim 1, wherein the scanner calibration data comprises a list of marking positions in world coordinates and the respective scanner settings; or
wherein the scanner calibration data comprises a list of offset vectors in world coordinates and the respective scanner settings, and the offset vectors each indicate an offset between the determined marking position and a theoretical position of the laser marking corresponding to the respective scanner setting; or
wherein the scanner calibration data comprises a correction file of parameters of a mathematical model that describes the relationship between positions in said world coordinate system and the corresponding scanner settings.

7. The method according to claim 1, wherein calibrating said scanner device further comprises verifying the scanner calibration data, wherein the following steps are carried out for a plurality of target pattern cells:
generating a verification laser marking on said calibration plate at a scanner setting corrected based on the scanner calibration data, which corresponds to a predetermined position in a target pattern cell;
capturing an image of the calibration plate at the corrected scanner setting by means of said observation device and determining a marking position of the verification laser marking on said calibration plate with respect to the target pattern cell; and
comparing the determined marking position of the verification laser marking with the predetermined position.

8. The method according to claim 1, further comprising calibrating said observation device with the steps of:
determining a position of a feature of a first target pattern cell in a first image of the calibration plate captured at a first scanner setting corresponding to the first target pattern cell, and determining a position of a feature of a second target pattern cell in a second image of the calibration plate captured at a second scanner setting that is shifted with respect to the first scanner setting and corresponds to the second target pattern cell, for each of a plurality of first and second scanner settings;
determining a feature shift by comparing the position of the feature of the first target pattern cell in the first image with a position of the feature of the second target pattern cell in the second image taking into account the shift between the first and second scanner settings and a period of the calibration pattern, for each of the plurality of first and second scanner settings; and
determining image calibration data for correcting the chromatic aberration for the scanner settings based on the determined feature shifts.

9. The method of claim 8, wherein for calibrating said observation device, the feature of the target pattern cell comprises at least one edge, at least one corner, a center point and/or a verification laser marking of the target pattern cell.

10. The method of claim 8, wherein calibrating said observation device for each of the plurality of first and second scanner settings comprises:
capturing the first image at the first scanner setting and capturing the second image at the second scanner setting, wherein the first and second scanner settings are corrected based on the scanner calibration data; or
wherein the first image is an image captured for calibrating said scanner device at the scanner setting corresponding to the respective first scanner setting and the second image is an image captured for calibrating said scanner device at the scanner setting corresponding to the respective second scanner setting, and the corresponding scanner calibration data are additionally taken into account when determining the feature shift.

11. The method according to claim 8, wherein
the image calibration data for correcting the chromatic aberration comprise a list of positions in world coordinates corresponding to the scanner settings and of the feature shifts determined for the scanner settings in pixel coordinates; or
wherein the image calibration data for correcting the chromatic aberration comprises a list of shift vectors in pixel coordinates and respective positions in world coordinates corresponding to the scanner settings, and the shift vectors each indicate a deviation of the position of the feature of the second target pattern cell in the second image from a theoretical position of the feature of the second target pattern cell to be expected based on the shift between the first and second scanner settings and a period of the calibration pattern.

12. The method according to claim 8, wherein the shift between the first and second scanner settings corresponds to a shift by at least one period of the calibration pattern, in particular by an integer multiple of the period of the calibration pattern.

13. The method according to claim 8, wherein the first target pattern cell and the second target pattern cell are consecutive pattern cells in the calibration pattern.

14. The method according to claim 8, wherein calibrating said observation device further comprises an image distortion correction, wherein the following steps are carried out for some or all of the first and/or second images:
correcting the image based on the image calibration data in order to correct the chromatic aberration according to the scanner setting when capturing the image;
determining pixel positions of at least one feature of a plurality of pattern cells in the corrected image; and
creating a model for image distortion correction based on a comparison of pixel distances between the determined pixel positions and corresponding distances of the respective features on said calibration plate in world coordinates for the respective scanner setting when capturing the image.

15. The method according to claim 1, wherein
the calibration pattern comprises a grid pattern or a checkerboard pattern, and/or
wherein the periodically arranged pattern cells are square, rectangular, quadrangular or triangular.

16. A laser machining system for machining a workpiece using a laser beam, comprising:
a scanner device for deflecting the laser beam to a plurality of positions on a surface;
an observation device, said observation beam path of which runs coaxially to said laser beam path over said scanner device; and
a control configured to carry out the method for calibrating said laser machining system according to claim 1.
